(19) United States
(12) Patent Application Publication
(10) Pub. No.: US 2016/0161805 A1
(43) Pub. Date: Jun. 9, 2016

(54) LIQUID CRYSTAL DISPLAY DEVICE

(71) Applicant: Samsung Display Co., Ltd., Yongin-si (KR)

(72) Inventors: Seunghyun PARK, Seoul (KR); Junho SONG, Seongnam-si (KR); Jeanho SONG, Yongin-si (KR)

(21) Appl. No.: 14/958,468

(22) Filed: Dec. 3, 2015

(30) Foreign Application Priority Data
Dec. 8, 2014 (KR) 10-2014-0174820

(51) Int. Cl. G02F 1/1337; G02F 1/1362; G02F 1/1343

(52) U.S. Cl. CPC G02F 1/133753; G02F 1/134336; G02F 1/133707; G02F 1/136286; G02F 2001/133757

(57) ABSTRACT

A liquid crystal display device including a display substrate coupled to an opposite substrate, with a liquid crystal layer therebetween. The display substrate includes pixel electrodes insulated from a common electrode. The pixel electrodes have branch electrodes arranged respectively in a plurality of pixel areas. A plurality of domains is defined in the plurality of pixel areas along column and row directions. The branch electrodes extend in a first direction respectively in domains arranged on an N'th row (N is a positive integer); the branch electrodes extend in both the first direction and a second and different direction in domains arranged on an [N+1]'th row; and the branch electrodes extend in the second direction respectively in domains arranged on an [N+2]'th row.

### CLAIM OF PRIORITY

A claim for priority under 35 U.S.C. §119 is made to Korean Patent Application No. 10-2014-0174820 filed Dec. 8, 2014, in the Korean Intellectual Property Office, the entire contents of which are hereby incorporated by reference.

### BACKGROUND OF THE INVENTION

The present inventions described herein relate to a liquid crystal display device, and more particularly, relate to a liquid crystal display device improved in expression quality.

Liquid crystal display device is a kind of means for expressing images by using a pair of substrates and a liquid crystal layer interposed between the substrates. Liquid crystal display device may be classified into In-Plane Switching (IPS) mode, Vertical Alignment (VP) mode, or Plane-to-Line Switching (PLS) mode in accordance with manner of activating the liquid crystal layer.

In a PLS liquid display device, pixel electrodes and a common electrode isolated from the pixel electrodes are disposed in one of two substrates. A liquid crystal layer thereof is activated under a horizontal electric field that is generated between the pixel electrodes and the common electrode. However, as the liquid crystal layer consists of molecules that have anisotropy of refractive index, images recognized by sight would be unequal to each other in dependence on view angle.

### SUMMARY OF THE INVENTION

One aspect of embodiments of the present invention is directed to provide a liquid crystal display device having improved expression quality.

According to one aspect of the present invention, there is provided a liquid crystal display device that includes a display substrate including a common electrode electrically insulated from a plurality of pixel electrodes that are arranged respectively in a corresponding plurality of pixel areas, each of the pixel electrodes includes a plurality of branch electrodes, an opposite substrate coupled to the display substrate and a liquid crystal layer arranged between the display substrate and the opposite substrate, wherein a plurality of domains are defined in the plurality of pixel areas in a column direction and in a row direction, wherein the branch electrodes extend in a first direction respectively in domains arranged on an N'th row (N is a positive integer); the branch electrodes extend in both the first direction and a second and different direction in domains arranged on an [N+1]'th row; and the branch electrodes extend in the second direction respectively in domains arranged on an [N+2]'th row, wherein each of the first and second directions forms an oblique angle with respect to the column direction.

The first direction and the second direction may be symmetrical to each other with respect to the column direction. The plurality of domains may include a plurality of first domains arranged on the N'th row, a plurality of second domains arranged on the [N+1]'th row and a plurality of third domains arranged on the [N+2]'th row, wherein each of the second domains may include first and second subdomains. A plurality of slits may be defined in the branch electrodes, lengthwise directions of the slits may extend in the first direction in each of the first domains; lengthwise directions of the slits may extend in the first direction in the first subdomains; lengthwise directions of the slits may extend in the second direction in the second subdomains; and lengthwise directions of the slits may extend in the second direction in the third domains.

Liquid crystal molecules of the liquid crystal layer in the first domains may be aligned to a first orientation, the liquid crystal molecules of the liquid crystal layer in the first subdomains may be aligned to the first orientation, the liquid crystal molecules of the liquid crystal layer in the second subdomains may be aligned to a second orientation that intersects the first orientation, and the liquid crystal molecules of the liquid crystal layer in the third domains may be aligned to the second orientation. The first and second orientations may each form an oblique angle with respect to the column direction. The plurality of domains may also include fourth domains arranged on an [N+4]'th row, each of the fourth domains may include third and fourth subdomains arranged in the column direction. The liquid crystal molecules may be aligned to the first orientation in the third subdomains, and the liquid crystal molecules may be aligned to the second orientation in the fourth subdomains.

The display substrate may also include a plurality of gate lines and a plurality of data lines intersecting the plurality of the gate lines to define the plurality of pixel areas, the data lines may extend in the first and second directions and in parallel to the branch electrodes. The first to third domains may be repeatedly arranged in the column direction. The first and second subdomains may be sequentially arranged in the column direction. The second and first subdomains may be sequentially arranged the column direction.

According to another aspect of the present invention, there is provided a liquid crystal display device that includes a display substrate including a common electrode electrically insulated from a plurality of pixel electrodes that are arranged respectively in a corresponding plurality of pixel areas, each of the pixel electrodes includes a plurality of branch electrodes, an opposite substrate coupled to the display substrate and a liquid crystal layer arranged between the display substrate and the opposite substrate, a plurality of domains may be defined in the plurality of pixel areas in a column direction and in a row direction, each of domains arranged on an N'th row (N being a positive integer) may have sides opposite each other that extend in a first direction, each of domains arranged on an [N+1]'th to [N+K]'th row (K being a positive integer ≧1) may have sides opposite each other that extend in both the first direction and a second direction that intersects the first direction, and each of domains arranged on an [N+K+1]'th row may have sides opposite each other that extend in the second direction, each of the first and second directions may form an oblique angle with respect to the column direction.

The first direction and the second direction may be symmetrical with respect to the column direction. The plurality of domains may include a plurality of first domains arranged on the N'th row, a plurality of second domains arranged respectively on the [N+1]'th to [N+K]'th rows and a plurality of third domains arranged on the [N+K+1]'th row, each of the second domains may include first and second subdomains arranged in the column direction. Liquid crystal molecules of the liquid crystal layer in the first domains may be aligned to a first orientation, the liquid crystal molecules of the liquid crystal layer in the first subdomain may also be aligned to the first orientation, the liquid crystal molecules of the liquid crystal layer in the second subdomain may be aligned to a second orientation that intersects the first orientation, and the liquid crystal molecules of the liquid crystal layer in the third domains may be aligned to the second orientation. Each of the first and second orientations may form an oblique angle with respect to the column direction.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a plan view illustrating pixels of a liquid crystal display device according to a first embodiment of the present invention;

FIG. 2 is a sectional view taken along I-I′ of FIG. 1;

FIG. 3 is a sectional vie taken along II-II′ of FIG. 1;

FIG. 4 illustrates a plurality of domains defined in the pixel areas shown FIG. 1;

FIG. 5 illustrates a plurality of domains defined in the pixel areas according to a second embodiment of the present invention;

FIG. 6 illustrates a plurality of domains defined in the pixel areas according to a third embodiment of the present invention; and

FIG. 7 illustrates a plurality of domains defined in the pixel areas according to a fourth embodiment of the present invention.

### DETAILED DESCRIPTION OF THE INVENTION

Embodiments will be described in detail with reference to the accompanying drawings. The present invention, however, may be embodied in various different forms, and should not be construed as being limited only to the illustrated embodiments. Rather, these embodiments are provided as examples so that this disclosure will be thorough and complete, and will fully convey the concept of the present invention to those skilled in the art. Accordingly, known processes, elements, and techniques are not described with respect to some of the embodiments of the present invention. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the present invention. As used herein, the singular forms “a”, “an” and “the” are intended to include the plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Now hereinafter will be described exemplary embodiments of the present invention in conjunction with accompanying drawings.

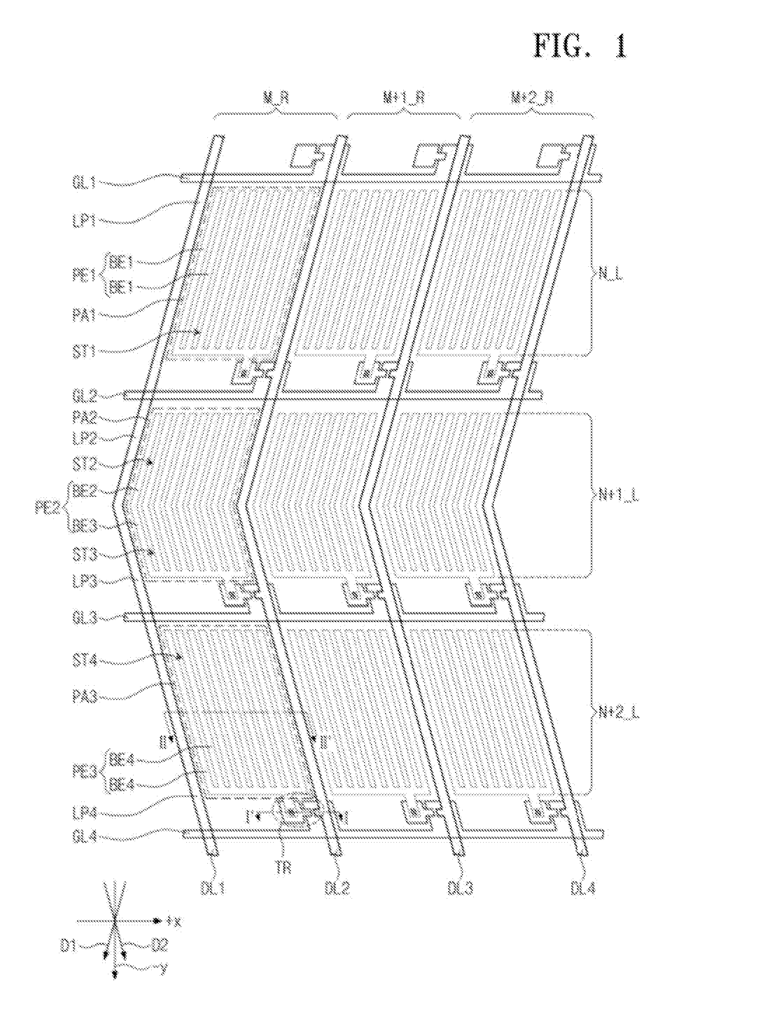

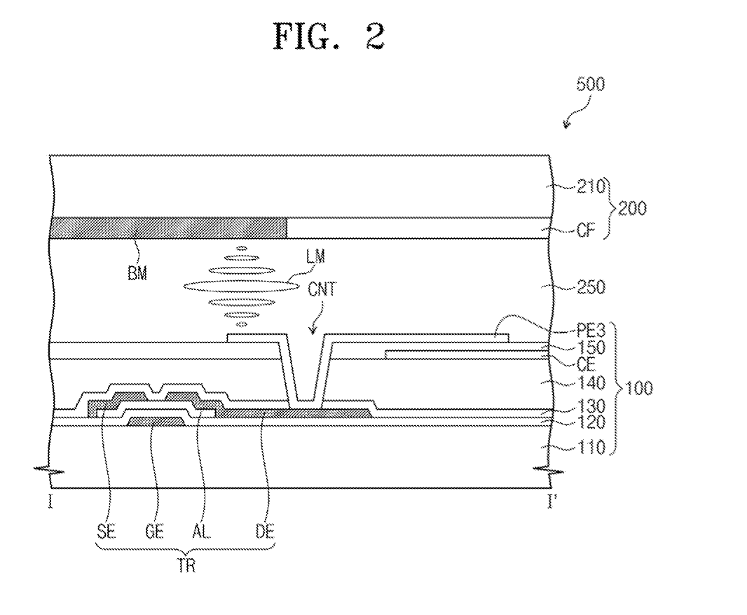

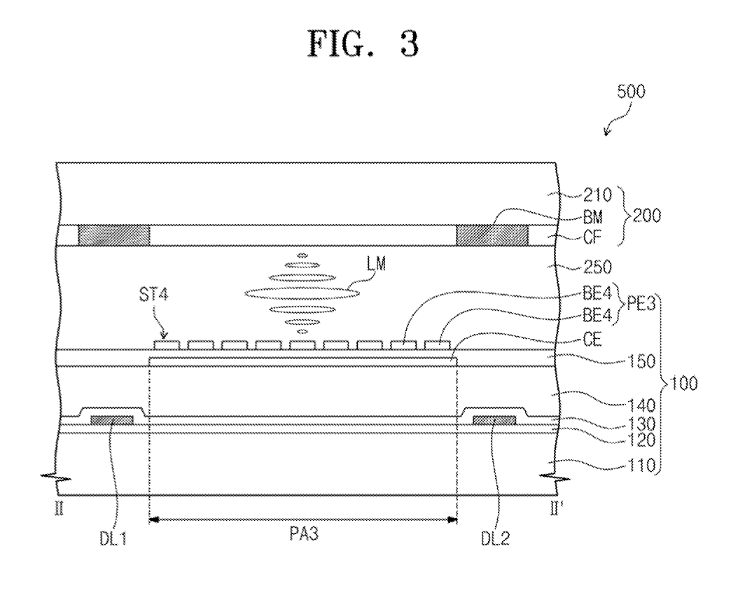

Turning now to FIGS. 1˜3, FIG. 1 is a plan view illustrating pixels of a liquid crystal display device according to a first embodiment of the present invention, FIG. 2 is a sectional view taken along I-I′ of FIG. 1, and FIG. 3 is a sectional vie taken along II-II′ of FIG. 1. Referring now to FIGS. 1˜3, the liquid crystal display device 500 includes a display substrate 100, an opposite substrate 200, and a liquid crystal layer 250. The display substrate 100 and the opposite substrate 200 are coupled each other. The liquid crystal layer 250 is disposed between the display substrate 100 and the opposite substrate 200. In this embodiment, the liquid crystal display device 500 may be configured to be driven in the PLS mode.

FIG. 1 illustrates a unit domain group that includes nine pixels arranged, among the pixels of the display substrate 100, in three rows and three columns. A remainder of the display can be formed by repeating the unit domain group in both the row and column directions.

The display substrate 100 includes a first substrate 110, a multiplicity of gate lines, a multiplicity of data lines, pixel electrodes, thin film transistors electrically connected with the pixel electrodes, and a common electrode CE.

The first substrate 110 has an optical transmittance like that of a glass substrate, and the gate lines are arranged on the first substrate 110. A first insulation film 120 is then arranged on the gate lines. The data lines are arranged on the first insulation film 120 and insulated from the gate lines by first insulation film 120.

The pluralities of the gate and data lines intersect each other to define the pixel areas. For instance, in the unit domain group of FIG. 1, the gate lines include the first to fourth gate lines GL1˜GL4 and the data lines include the first to fourth data lines DL1˜DL4. A first pixel area PA1 is defined by first and second gate lines GL1 and GL2 intersecting first and second data lines DL1 and DL2. In the same manner, the second and third gate lines GL2 and GL3 may intersect the first and second data lines DL1 and DL2, thereby defining a second pixel area PA2. The third and fourth gate lines GL3 and GL4 may intersect the first and second data lines DL1 and DL3, thereby defining a third pixel area PA3.

In the same manner as first to third pixel areas PA1˜PA3, the first to fourth gate lines GL1˜GL4 and data lines DL1˜DL4 may intersect each other to define all nine pixel areas of the unit domain group arranged in row and column directions +x and −y. These nine pixel areas of the unit domain group may be arranged in a matrix of three rows and three columns. In the unit domain group of FIG. 1, three pixel areas may be arranged in each of the N'th row N_L, an [N+1]'th row N+1_L, and an [N+2]'th row N+2_L (N being a positive integer) in the row direction +x. In the unit domain group of FIG. 1, three pixel areas are also arranged in each of the M'th column M_R the [M+1]'th column M+1_R, and the [M+2]'th column M+2_R in the column direction −y (M being a positive integer).

The thin film transistors are electrically connected to the pixel electrodes to switch drive signals that are applied to the pixel electrodes. One of the thin film transistors TR has a structure as follows. The thin film transistor TR includes a gate electrode GE, an active layer AL, a source electrode SE, and a drain electrode DE. The gate electrode GE illustrated in FIG. 2 branches out from the fourth gate line GL4 of FIG. 1, and is disposed on the first substrate 110. The active layer AL includes a semiconductor material and is arranged on the gate electrode GE, with an intervening first insulation film 120 therebetween. The source electrode SE of FIG. 2 branches out from the second data line DL2, and overlaps the active layer AL. The drain electrode DE is separated from the source electrode SE, and also overlaps the active layer AL.

The thin film transistor TR and the first and second data lines DL1 and DL2 are covered by a second insulation film 130 and a third insulation film 140. In this embodiment, the second insulation film 130 may include an inorganic insulator while the third insulation film 140 may include an organic insulator.

The pixel electrodes are disposed in correspondence with the pixel areas one by one. For example, a first pixel electrode PE1 is arranged within the first pixel area PA1, a second pixel electrode PE2 is arranged within the second pixel area PA2, and a third pixel electrode PE3 is arranged within the third pixel area PA3.

The pixel electrodes may be electrically connected to the thin film transistors one by one. For example, a contact hole CNT may be formed to perforate the second and third insulation films 130 and 140 to electrically connect a pixel electrode to a thin film transistor. As illustrated in FIG. 2, the third pixel electrode PE3 is electrically connected to the drain electrode DE of a thin film transistor arranged within third pixel area PA3.

In this first embodiment, each of the pixel electrodes may include a plurality of branch electrodes. For instance, the first pixel electrode PE1 may include first branch electrodes BE1, the second pixel electrode PE2 may include second branch electrodes BE2 and third branch electrodes BE3, and the third pixel electrode PE3 may include fourth branch electrodes BE4.

The common electrode CE is disposed on the third insulation film 140. Additionally, a fourth insulation film 150 is disposed on the common electrode CE, and the pixel electrodes are disposed on the fourth insulating film 150. The common electrode may therefore be insulated from the plurality of pixel electrodes by the fourth insulation film 150. By applying a common voltage to the common electrode CE, a horizontal electric field can be induced between the common electrode CE and the plurality of pixel electrodes. Consequently, the electric field may determine an orientation of liquid crystal molecules LM arranged within the liquid crystal layer 250.

The opposite substrate 200 is coupled to the display substrate 100. In this embodiment, the opposite substrate 200 may include a second substrate 210, light shielding layers BM, and color filters CF. The second substrate 200 may have an optical transmittance as like that of a glass substrate. The color filers CF may be arranged on the second substrate 200 at locations corresponding to the pixel areas. The light shielding layers BM may be disposed on the second substrate 200 at locations external to the pixel areas.

In the first embodiment, the first to third pixel electrodes PE1˜PE3 may have different shapes. In more detail, the first and second branch electrodes BE1 and BE2 extend along a first direction D1, while the third and fourth branch electrodes BE3 and BE4 extend along a second and different direction D2.

In the first embodiment, the first and second directions D1 and D2 may each be slanted (i.e. form an oblique angle) with respect to the column direction −y. The first direction D1 and the second direction D2 may be symmetrical to each other with respect to the column direction −y.

Additionally, a first slit ST1 is defined between two adjacent ones of the first branch electrodes BE1, a second slit ST2 is defined between two adjacent ones of the second branch electrodes BE2, a third slit ST3 is defined between two adjacent ones of the third branch electrodes BE3, and a fourth slit ST4 is defined between two adjacent ones of the fourth branch electrodes BE4.

As described above, if the first to fourth branch electrodes BE1˜BE4 are defined by their extending directions, the first to fourth slits ST1˜ST4 may be defined with their lengthwise directions. In more detail, the lengthwise directions of the first and second slits ST1 and ST2 are parallel to first direction D1, while the lengthwise directions of the third and fourth slits ST3 and ST4 are parallel to second direction D2.

In this first embodiment, the plurality of data lines DL1, DL2, . . . may also extend along the first and second directions D1 and D2, and may be parallel to the first to fourth branch electrodes BE1˜BE4. Specifically, the first data line DL1 may include a first line portion LP1, a second line portion LP2, a third line portion LP3, and a fourth line portion LP4. The first line portion LP1 may extend in the first direction D1 that is parallel to the first branch electrodes BE1, and the second line portion LP2 of first data line DL1 may also extend in the first direction D1 that is parallel to the second branch electrodes BE2. Additionally, the third line portion LP3 may extend in the second direction D2 that is parallel to the third branch electrodes BE3, and the fourth line portion LP4 of first data line DL1 may also extend in the second direction D2 that is parallel to the fourth branch electrodes BE4.

As described above, owing to the arrangement that the first data line DL1 extends along the first and second directions D1 and D2 and in parallel with the first to fourth branch electrodes BE1˜BE4, it is possible to space-apart the first data line DL1 from the first to fourth branch electrodes BE1˜BE4 by a uniform distance. If this distance is minimized, it is possible to interrupt leakage of light emitted from the backlight assembly.

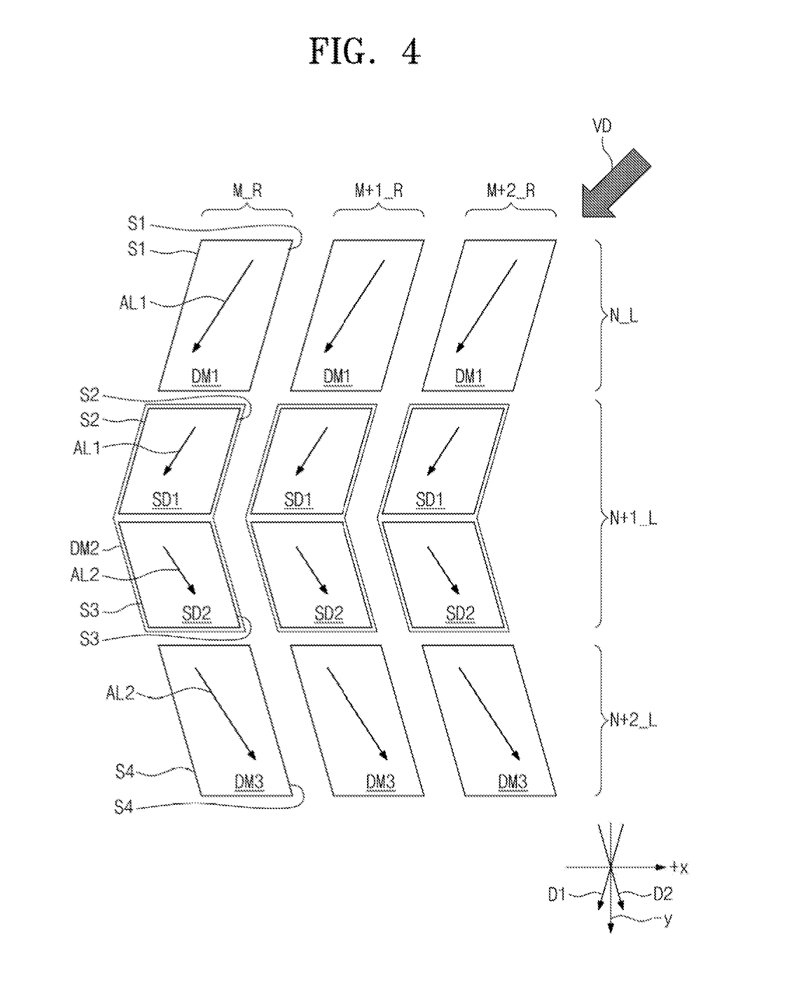

Turning now to FIG. 4, FIG. 4 illustrates a plurality of domains defined in the pixel areas of FIG. 1 according to the first embodiment of the present invention. Referring now to FIGS. 1 and 4, three domains DM1, DM2, and DM3 may be present in pixels of a unit domain group according to the first embodiment of the present invention. This unit domain group is defined by the N'th row N_L, the [N+1]'th row N+1_L, the [N+2]'th row N+2_L, the M'th column M_R, the [M+1]'th column M+1_R, and the [M+2]'th column M+2_R. As previously described, since the first to third pixel electrodes PE1˜PE3 are structured differently from each other, the three domains DM1, DM2, and DM3 arranged on a same column are also configured differently from each other. However, in the unit domain group of FIG. 1, the pixel electrodes arranged on a same row are the same as each other in structure, and vary only in the column direction −y.

A unit domain group may be defined by a combination with the N'th row N_L, the [N+1]'th row N+1_L, the [N+2]'th row N+2_L, the M'th column M_R, the [M+1]'th column M+1_R, and the [M+2]'th column M+2_R. This unit domain group may be repeatedly arranged over an entirety of the display. That is, the first domain DM1 may be disposed on an [N+3]'th row, the second domain DM2 may be disposed on an [N+4]'th row, and the third domain DM3 may be disposed on an [N+5]'th row.

In this first embodiment, as the second pixel electrode PE2 includes the second branch electrodes BE2 extending in the first direction D1, and the third branch electrodes BE3 extending in the second direction D2, the second domain DM2 may be divided into first and second subdomains SD1 and SD2. The subdomains SD1 and SD2 of the second domain DM2 may be arranged in sequence along the column direction −y.

The first domain DM1 has a pair of first sides S1 extending in the first direction D1 while facing to each other, and the first subdomain SD1 of the second domain DM2 has a pair of second sides S2 extending in the first direction D1 while facing each other. Additionally, the second subdomain SD2 of the second domain DM2 has a pair of third sides S3 extending in the second direction D2 while facing to each other, and the third domain DM3 has a pair of fourth sides S4 extending in the second direction D2 while facing each other.

In the first domain DM1 of the first embodiment, the liquid crystal molecules (LM of FIG. 3) of the liquid crystal layer may be aligned to have a first orientation AL1. In more detail, when an electric field is generated between the first pixel electrode PE1 and the common electrode (CE of FIG. 3) and the liquid crystal molecules have positive dielectric anisotropy, the liquid crystal molecules may be aligned to have the first orientation AL1 in the first domain DM1 due to the electric field as indicated by the director.

The liquid crystal molecules may also be aligned to have the first orientation AL1 in the first subdomain SD1, aligned to have a second orientation AL2 in the second subdomain SD2, and aligned to also have the second orientation AL2 in the third domain DM3. In this embodiment, the first orientation AL1 may intersect the second orientation AL2, while being symmetrical to the second orientation AL2 with respect to the column direction −y.

As described above, in case that the orientations of the liquid crystal molecules are defined in the first to third domains DM1˜DM3, by including a second domain DM2 interposed between the first domain DM1 and the third domain DM3, and by having the second domain DM2 include both first and second subdomains SD1 and SD2 having different orientation directions AL1 and AL2, the dark lines or the luminance lines ordinarily observed due to the boundary between the first and third domains DM1 and DM3 at a view angle VD can be eliminated.

In further detail, if the view angle VD is closer to the first orientation AL1 than to the second orientation AL2 as illustrated in FIG. 4, a first refractive index anisotropy of the liquid crystal layer, which is determined by the first domain DM1, is smaller than a third refractive index anisotropy of the liquid crystal layer, which is determined by the third domain DM3. Additionally, as the second domain DM2 includes both the first and second subdomains SD1 and SD2 having different orientations from each other, a second refractive index anisotropy of the second domain DM2 is larger than the first refractive index anisotropy and smaller than the third refractive index anisotropy.

In comparison, in an arrangement different from the teachings and embodiments of the present invention, the first and third domains DM1 and DM3 are adjacently arranged without interposing the second domain DM2 therebetween. As a result, a difference between the first and third refractive index anisotropies may produce visible luminance lines or dark lines in correspondence with a difference of luminance between the first and third domains DM1 and DM3. However, as can be understood from this embodiment of the present invention, the second domain DM2 is interposed between the first and third domains DM1 and DM3. As a result, it is possible for luminance of the second domain DM2 to offset the luminance difference between the first and third domains DM1 and DM3, thereby preventing a user from visually perceiving luminance lines or dark lines.

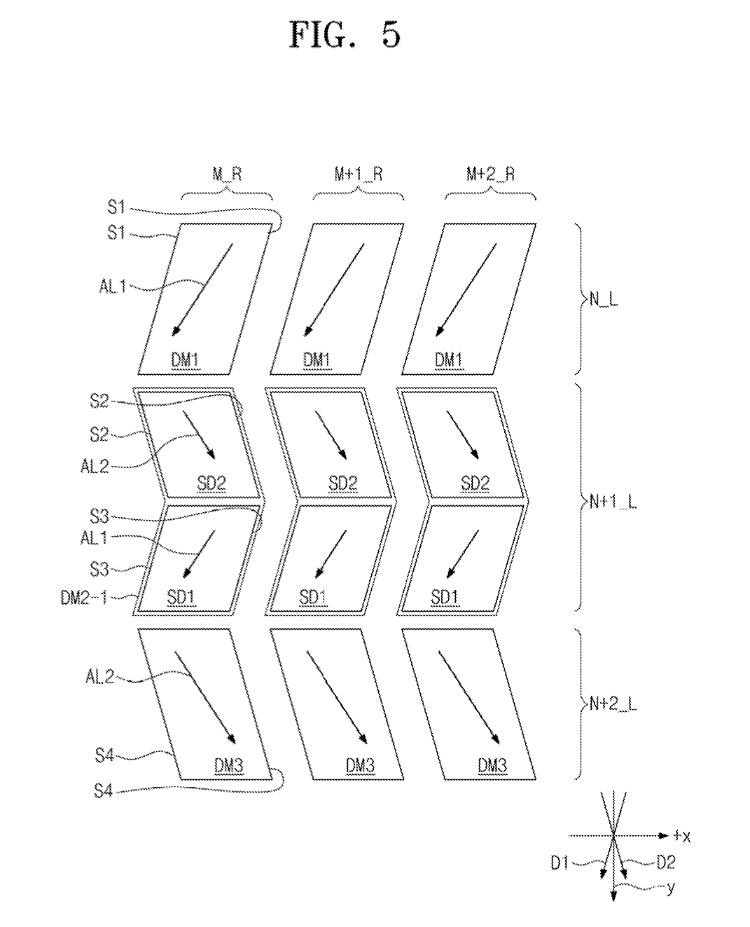

Turning now to FIG. 5, FIG. 5 illustrates a unit domain group including a plurality of domains defined in the pixel areas in accordance with a second embodiment of the present invention. In the description of FIG. 5, similar reference numerals are used for like features in FIGS. 1 to 4, and a detailed description thereof will therefore not be repeated here.

In the first embodiment of FIG. 4, the first and second subdomains SD1 and SD2 of the second domain DM2 are sequentially arranged in the column direction −y. However, in the second embodiment of FIG. 5, the first and second subdomains SD1 and SD2 of a second domain DM2-1 are sequentially arranged in a reverse order in the column direction −y as compared to that of FIG. 4.

In the same manner as the first embodiment of FIG. 4, in the second embodiment of FIG. 5, the second domain DM2-1 is disposed on the [N+1]'th row N+1_L to prevent the user from visually perceiving luminance lines or dark lines due to a luminance difference between the N'th and [N+2]'th rows N_L and N+2_L.

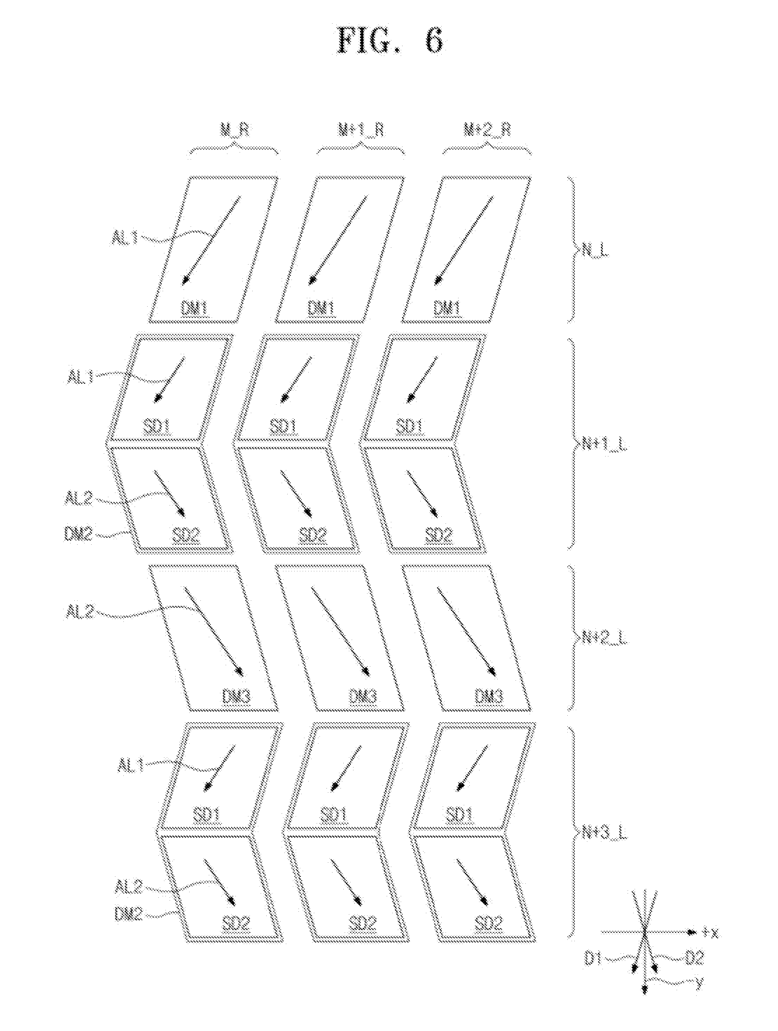

Turning now to FIG. 6, FIG. 6 illustrates a unit domain group including a plurality of domains defined in pixel areas of a third embodiment of the present invention. In the description of FIG. 6, like components illustrated in FIGS. 1 to 4 have a same reference numerals, and their descriptions are therefore not repeated here.

Referring now to FIG. 6, the first domains DM1 are arranged on the N'th row N_L, the second domains DM2 are arranged on the [N+1]'th row N+1_L, the third domains DM3 are arranged on [N+2]'th row N+2_L, and the second domains DM2 are again arranged on the [N+3]'th row N+3_L. Accordingly, in each of the M'th, [M+1]'th, [M+2]'th columns, M_R, M+1_R, and M+2_R, the first domain DM1, the second domain DM2, the third domain DM3, and the second domain DM2 are sequentially arranged in the column direction −y in this order. Furthermore, unlike the first and second embodiments, the third embodiment has a repeating structure (i.e. unit domain group) for every 4 domains in the column direction −y, which is unlike the first and second embodiments where the structure repeats after every three domains. As a result, the unit domain group according to the third embodiment of FIG. 6 includes the N'th row N_L, the [N+1]'th row N+1_L, the [N+2]'th row N+2_L, the [N+3]'th row N+3_L, the M'th column M_R, the [M+1]'th column M+1_R, and the [M+2]'th column M+2_R, and this unit domain group may be repeatedly arranged over the whole area of the pixels in this third embodiment. In other words, this unit domain group includes twelve pixel areas, and the first domains DM may again be arranged on an [N+4]'th row, the second domains DM2 may again be arranged on an [N+5]'th, the third domains DM3 may again be arranged on an [N+6]'th row, and then the second domains DM2 may again be arranged again on an [N+7]'th row.

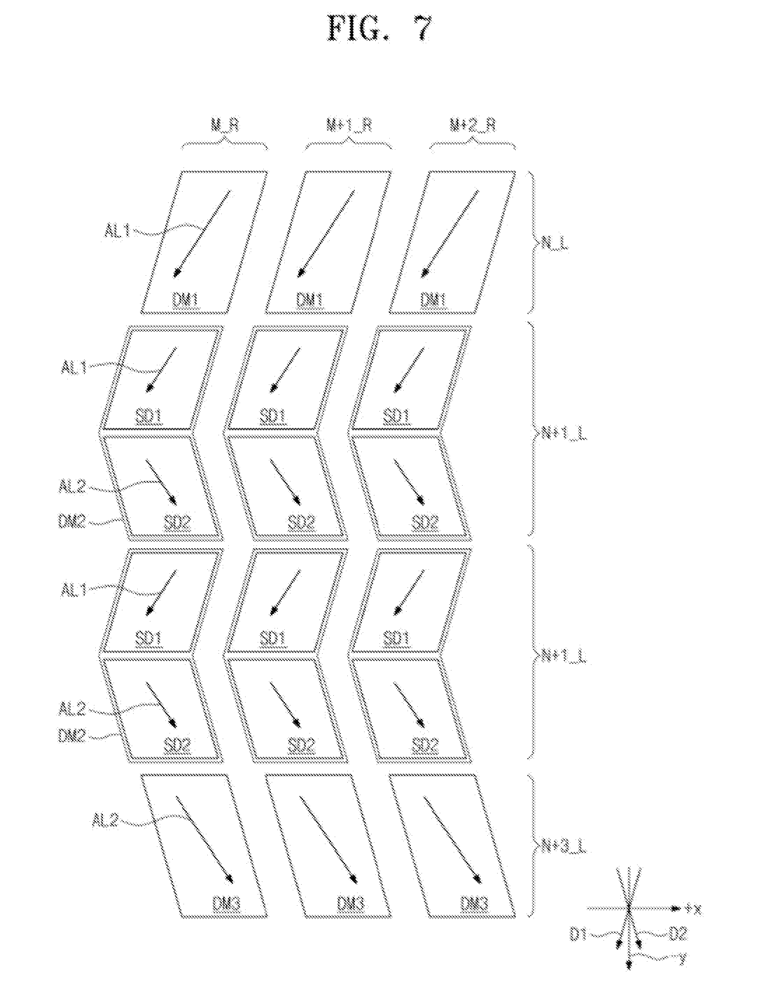

Turning now to FIG. 7, FIG. 7 illustrates a unit domain group of pixel areas according to a fourth embodiment of the present invention. In the following description of FIG. 7, like components to that of FIGS. 1 to 4 have same reference numerals, and a detailed description thereof will not be repeated here.

Referring now to FIG. 7, the first domains DM1 are arranged on the N'th row N_L, the second domains DM2 are arranged on the [N+1]'th row N+1_L, the second domains DM2 are again arranged on the [N+2]'th row N+2_L, and then the third domains DM3 are arranged on the [N+3]'th row N+3_L.

As a result, the unit domain group according to the fourth embodiment of FIG. 7 includes the N'th row N_L, the [N+1]'th row N+1_L, the [N+2]'th row N+2_L, the [N+3]'th row N+3_L, the M'th column M_R, the [M+1]'th column M+1_R, and the [M+2]'th column M+2_R, and this unit domain group that includes twelve pixel areas may be repeatedly arranged over the whole area of the pixels in this fourth embodiment. In other words, the first domains DM1 may be arranged on an [N+4]'th row, the second domains DM2 may be arranged on an [N+5]'th, the second domains DM2 may again be rearranged on an [N+6]'th row, and then the third domains DM3 may be arranged again on an [N+7]'th row. Consequently, like the third embodiment of FIG. 6 and unlike the first and second embodiments of FIGS. 1-5, an repeating unit domain group has four rows and four domains extending in the column direction −y instead of three.

In conclusion, the present invention includes an extra domain between two domains which are known to show different luminance when viewed by a user at a view angle, thereby preventing the user from perceiving the difference in luminance. Consequently, it is permissible to prevent a user from visually perceiving luminance lines or dark lines, thereby improving expression quality of the liquid crystal display device.

The present invention pertains to a novel design for an LCD display device. The inventors have recognized that earlier designs for an LCD display device result in the viewer perceiving dark lines and luminance lines when viewed at an angle. The inventors have also recognized that these dark lines or luminance lines are caused by abrupt changes in the refractive index anisotropies of two adjoining and different domains in a pixel matrix structure. In other words, the inventors have recognized that when one pixel having a first domain having a first refractive index anisotropy is arranged adjacent to another domain having a second and different refractive index anisotropy, that dark lines and luminance lines can be observed when the display is viewed from an angle.

In each of these embodiments, each of the pixel electrodes in each of the domains in a first row includes a plurality of branches and a plurality of slits that extend and a first direction D1 that forms an oblique angle with that of the column direction −y. In the third row, the branches, slits and domains extend in a second direction D2 that also forms an oblique angle with the column direction −y. This produces a kind of a zig-zag pattern for the branches and slits of the pixel electrodes. The first direction D1 and the second direction D2 are symmetrical with respect to the column direction −y in each of these embodiments. Furthermore, not only do the branches and slits extend in the first and second directions D1 or D2, but also the data lines and the edges of the pixel areas extend in one of the first and second directions D1 and D2. Furthermore, each of the embodiments pertains to a common electrode and a pixel electrode formed on a same substrate, separated from each other by a thin insulating layer. Consequently, each of the embodiments body a plane-to-line (PLS) switching mode for an LCD display device.

The inventors overcome the problem of dark lines and luminance lines caused by sharp and abrupt changes in the refractive index anisotropies of the liquid crystal layer by interposing a domain between the first and third domains having the differing refractive index anisotropies. In this intervening second domain, the second domain can be divided into first and second subdomains, wherein one of the first and second subdomains has a refractive index anisotropy similar to that of the first domain, and an other of the subdomains has a refractive index anisotropy being similar to that of the third domain. By including such an intervening domain comprised of two different subdomains between two domains having different refractive index anisotropies, the inventors have found that the intervening second domain offsets the luminance difference between the first and third domains, thereby eliminating the dark lines and luminance lines.

The inventors have described several embodiments that employ this concept. In the first and third embodiments of FIGS. 1 and 5, a unit domain group is comprised of nine pixel areas arranged in three rows and three columns. In the third and fourth embodiments of FIGS. 6 and 7, a unit domain group includes 12 pixel areas having four rows and three columns. Regarding the unit domain groups that have nine pixel areas in three rows and three columns, the middle row or second row has a first subdomain adjacent to the first row having a domain orientation similar to that of one of the first and third rows, and the second subdomain has an orientation similar to the other of the first and the third rows. Hence, FIG. 5 merely reverses the subdomains of FIG. 1.

In each of the third and fourth embodiments of FIGS. 6 and 7, there are second rows each having two subdomains therein. In the embodiment of FIG. 6, second row is repeated after the third row (i.e. in the fourth row) to produce a unit domain group having four rows and pixel areas. In the fourth embodiment of FIG. 7, second row is repeated back to back between the first and third domains, to also produce a unit domain group having 12 pixel areas.

While the present invention has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A liquid crystal display device, comprising:
a display substrate including a common electrode electrically insulated from a plurality of pixel electrodes that are arranged respectively in a corresponding plurality of pixel areas, each of the pixel electrodes includes a plurality of branch electrodes;
an opposite substrate coupled to the display substrate; and
a liquid crystal layer arranged between the display substrate and the opposite substrate,
wherein a plurality of domains are defined in the plurality of pixel areas in a column direction and in a row direction,
wherein the branch electrodes extend in a first direction respectively in domains arranged on an N'th row (N is a positive integer); the branch electrodes extend in both the first direction and a second and different direction in domains arranged on an [N+1]'th row; and the branch electrodes extend in the second direction respectively in domains arranged on an [N+2]'th row,
wherein each of the first and second directions forms an oblique angle with respect to the column direction.

2. The liquid crystal display device of claim 1, wherein the first direction and the second direction are symmetrical to each other with respect to the column direction.

3. The liquid crystal display device of claim 1, wherein the plurality of domains comprise:
a plurality of first domains arranged on the N'th row;
a plurality of second domains arranged on the [N+1]'th row; and
a plurality of third domains arranged on the [N+2]'th row,
wherein each of the second domains comprises first and second subdomains.

4. The liquid crystal display device of claim 3, wherein a plurality of slits are defined in the branch electrodes,
wherein lengthwise directions of the slits extend in the first direction in each of the first domains; lengthwise directions of the slits extend in the first direction in the first subdomains;
lengthwise directions of the slits extend in the second direction in the second subdomains; and
lengthwise directions of the slits extend in the second direction in the third domains.

5. The liquid crystal display device of claim 3, wherein liquid crystal molecules of the liquid crystal layer in the first domains are aligned to a first orientation; the liquid crystal molecules of the liquid crystal layer in the first subdomains are aligned to the first orientation; the liquid crystal molecules of the liquid crystal layer in the second subdomains are aligned to a second orientation that intersects the first orientation; and the liquid crystal molecules of the liquid crystal layer in the third domains are aligned to the second orientation.

6. The liquid crystal display device of claim 5, wherein the first and second orientations each form an oblique angle with respect to the column direction.

7. The liquid crystal display device of claim 5, wherein the plurality of domains further comprises fourth domains arranged on an [N+4]'th row,
wherein each of the fourth domains includes third and fourth subdomains arranged in the column direction.

8. The liquid crystal display device of claim 7, wherein the liquid crystal molecules are aligned to the first orientation in the third subdomains, and the liquid crystal molecules are aligned to the second orientation in the fourth subdomains.

9. The liquid crystal display device of claim 3, wherein the display substrate further comprises:
a plurality of gate lines; and
a plurality of data lines intersecting the plurality of the gate lines to define the plurality of pixel areas,
wherein the data lines extend in the first and second directions and in parallel to the branch electrodes.

10. The liquid crystal display device of claim 3, wherein the first to third domains are repeatedly arranged in the column direction.

11. The liquid crystal display device of claim 3, wherein the first and second subdomains are sequentially arranged in the column direction.

12. The liquid crystal display device of claim 3, wherein the second and first subdomains are sequentially arranged the column direction.

13. A liquid crystal display device, comprising:
a display substrate including a common electrode electrically insulated from a plurality of pixel electrodes that are arranged respectively in a corresponding plurality of pixel areas, each of the pixel electrodes includes a plurality of branch electrodes;
an opposite substrate coupled to the display substrate; and
a liquid crystal layer arranged between the display substrate and the opposite substrate,
wherein a plurality of domains are defined in the plurality of pixel areas in a column direction and in a row direction,
wherein each of domains arranged on an N'th row (N being a positive integer) has sides opposite each other that extend in a first direction; each of domains arranged on an [N+1]'th to [N+K]'th row (K being a positive integer ≧1) has sides opposite each other that extend in both the first direction and a second direction that intersects the first direction; and each of domains arranged on an [N+K+1]'th row has sides opposite each other that extend in the second direction,
wherein each of the first and second directions form an oblique angle with respect to the column direction.

14. The liquid crystal display device of claim 13, wherein the first direction and the second direction are symmetrical with respect to the column direction.

15. The liquid crystal display device of claim 13, wherein the plurality of domains comprises:
a plurality of first domains arranged on the N'th row;
a plurality of second domains arranged respectively on the [N+1]'th to [N+K]'th rows; and
a plurality of third domains arranged on the [N+K+1]'th row,
wherein each of the second domains comprises first and second subdomains arranged in the column direction.

16. The liquid crystal display device of claim 15, wherein liquid crystal molecules of the liquid crystal layer in the first domains are aligned to a first orientation; the liquid crystal molecules of the liquid crystal layer in the first subdomain are also aligned to the first orientation; the liquid crystal molecules of the liquid crystal layer in the second subdomain are aligned to a second orientation that intersects the first orientation; and the liquid crystal molecules of the liquid crystal layer in the third domains are aligned to the second orientation.

17. The liquid crystal display device of claim 16, wherein each of the first and second orientations form an oblique angle with respect to the column direction.
